(19) United States
(12) Patent Application Publication
(10) Pub. No.: US 2026/0197529 A1
(43) Pub. Date: Jul. 9, 2026

(54) PROFILES FOR CONFIGURING MEDIA DEVICES IN VARIOUS LOCATIONS

(71) Applicant: DISH Network L.L.C., Englewood, CO (US)

(72) Inventors: Ryan Burr Scribner, Erie, CO (US); Aaron Schwartz, Denver, CO (US); Joshua Wade, Castle Rock, CO (US); Jason Madruga, Castle Rock, CO (US); Clark Pendery, Englewood, CO (US)

(73) Assignee: DISH Network L.L.C., Englewood, CO (US)

(21) Appl. No.: 19/009,224

(22) Filed: Jan. 3, 2025

(51) Int. Cl. H04N 21/475

(52) U.S. Cl. CPC H04N 21/4753; H04N 21/4755

(57) ABSTRACT

In one example, an automated process comprises linking, by a device configuration manager (DCM), an account of a guest to a unique identifier of the guest received from a property management system (PMS). The DCM stores configuration data of a playback device in association with the account in response to the playback device being configured while assigned to the guest. The configuration data identifies a content application installed on the playback device. An authorization prompt can authorize storage of a login credential for the content application. The login credential can be stored in response to receiving the authorization. The content application is deleted from the playback device in response to a departure of the guest. Other examples and related methods are also disclosed herein.

### TECHNICAL FIELD

The following generally relates to content delivery. More particularly, the following relates to systems, devices, and automated processes to deliver content using media-playback devices.

### BACKGROUND

Travelers frequently encounter challenges when staying at hotels or vacation rentals, particularly regarding access to smart TV applications. Set-back boxes or other playback devices can have limited resources that can limit onboard storage. Many accommodations thus do not offer comprehensive access to popular streaming services and apps, limiting guests'ability to enjoy their preferred content. This situation is exacerbated by the fact that devices, such as set-top boxes or set-back boxes, often cannot store all relevant applications locally. As a result, travelers must download and configure their applications each time they visit a new hotel or rental property.

This process can be time-consuming and frustrating, particularly for frequent travelers who may need to repeatedly log into various accounts and adjust settings to customize their viewing experience. Moreover, inconsistent Wi-Fi availability or varying internet speeds in different locations can further complicate the situation, leading to interruptions in service or challenges in accessing specific applications. Guests are often forced to sift through application repositories, remember user logins, change passwords, download apps, or otherwise struggle to access their content while traveling. The hassle detracts from the overall guest experience, creating a need for a more efficient and user-friendly system that enhances convenience and accessibility for travelers.

### BRIEF SUMMARY

Systems, methods, and devices of the present disclosure manage user experiences at temporary dwelling locations. An example of an automated process comprises linking, by a device configuration manager (DCM), an account of a guest to a unique identifier of the guest received from a property management system (PMS). The DCM stores configuration data of a playback device in association with the account in response to the playback device being configured while assigned to the guest. The configuration data identifies a content application installed on the playback device. An authorization prompt can authorize storage of a login credential for the content application. The login credential can be stored in response to receiving the authorization. The content application is deleted from the playback device in response to a departure of the guest.

In various embodiments, the unique identifier comprises an account number for a hotel rewards program. The account is created in response to the guest submitting an email address. The account comprises a dummy account created without input from the guest. The configuration data comprises a favorite channel identified during a stay of the guest. The DCM installs the content application on a second playback device in response to receiving the unique identifier from the PMS. The DCM updates the configuration data in response to the guest installing a second content application on the second playback device. The second playback device is reset to a default configuration in response to a second departure of the guest.

Another example process includes assigning a dwelling unit to a user. The dwelling unit includes an assigned playback device. A unique identifier associated with the user is transmitted to a DCM to retrieve configuration data of the user. The assigned playback device is configured based on the configuration data. The assigned playback device is reset to a default configuration in response to departure of the user from the dwelling unit.

In various examples, The configuration data of the user is updated at the DCM in response to a content application being installed on the assigned playback device. The configuration data of the user comprises a content application installed on the assigned playback device and a login credential for the content application. A target playback device is configured in a second dwelling unit in response to the user being assigned to the second dwelling unit. The target playback device is reset to the default configuration in response to the user checking out of the second dwelling unit. The configuration data of the assigned playback device is transmitted to the DCM for configuration of other playback devices assigned to the user.

An example of a computer-based system can include a first playback device located in a first dwelling unit at a first property. A second playback device can be located in a second dwelling unit at a second property. A device configuration manager (DCM) is configured to manage the first playback device and the second playback device. The DCM associates configuration data from the first playback device with a unique identifier of a user in response to the user being assigned the first dwelling unit. The DCM configures the second playback device using the configuration data from the first playback device in response to the user being assigned the second dwelling unit.

In various embodiments, the DCM updates the configuration data in response to the user installing a content application on the second playback device. The configuration data includes an installed content application and login credentials for the installed content application. A property management system (PMS) includes the DCM. The DCM is in electronic communication over a network with a property management system (PMS) that manages the first property and the second property. The PMS provides the unique identifier comprising a rewards account number to the DCM.

Other examples may be found in the figures, in the claims, or in the description of the present disclosure.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the illustrations.

FIG. 1 illustrates an example playback device, in accordance with various embodiments.

FIG. 2 illustrates an example system for managing content applications on playback devices, in accordance with various embodiments.

FIG. 3 illustrates an example process for managing content applications on playback devices, in accordance with various embodiments.

FIG. 4 illustrates an example process for managing content applications on playback devices, in accordance with various embodiments.

FIG. 5 illustrates an example process for managing content applications on playback devices, in accordance with various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

Systems, methods, and devices (collectively, the “System”) of the present disclosure simplify content access for users. The System can be based on one or more unique identifiers assigned to an individual user. The user's content preferences, applications, login credentials, viewing history, transaction history, or other related data can be stored in association with the unique identifier. A centralized content manager can configure remote set-back boxes (SBB) or other playback devices in anticipation of, or in response to, a user gaining access to the SBB or playback device.

For example, a hotel chain can store the user's configuration of a playback device during an initial visit to the hotel then automatically wipe the playback device upon checkout. For subsequent visits to the same location or different locations, the hotel chain can configure the SBB in the user's room to the stored configuration. Configuration can occur before, during, or after check in. Updates can be made to the profile and can be automatically applied on future visits. The user's preferences and profile can be linked across multiple lodging providers and types, such as hotel chains, vacation rentals, office spaces, or other guest arrangements.

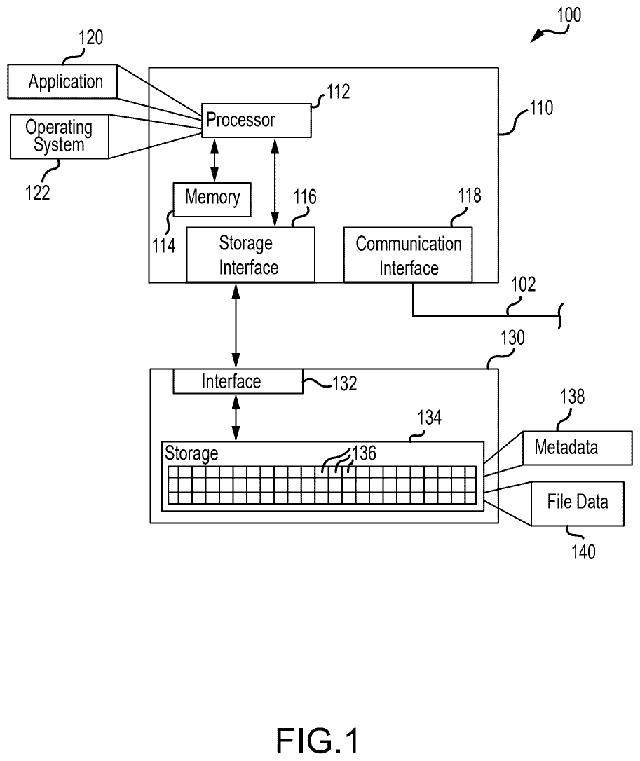

Referring now to FIG. 1, an example computing device 100 is shown, in accordance with various embodiments. Computing device 100 can comprise a laptop, computer, server, smartphone, media-playback device, set-top box (STB), set-back box (SBB), television, placeshifting device, playback device, virtual machine, container, cloud-computing system, or other type of computing device compatible with the systems, methods, and devices described herein. In some embodiments, computing device 100 can be an SBB or STB in communication with a centralized management system for traveling guests.

In various embodiments, computing device 100 may include a processing component 110 and a storage component 130. Computing device 100 may include one or more user interfaces, for input or output such as a remote control, keyboard, mouse, track ball, touch pad, touch screen, or a display. Processing component 110 may include a processor 112 and a memory 114. Memory 114 may be in electronic communication with processor 112. Processor 112 may include one or more microprocessors, co-processors, logic devices, or the like. Processor 112 comprising multiple microprocessors may execute in parallel or asynchronously. The logic device may include, for example, analog-to-digital converters, digital-to-analog converters, buffers, multiplexers, clock circuits, or any other peripheral devices required for operation of processor 112.

Memory 114 may include a single memory device or multiple memory devices and may be volatile memory, non-volatile memory, or a combination thereof. In some embodiments, memory 114 may comprise a non-transitory memory configured to store instructions thereon that, when executed by processor 112 or computing device 100, cause the respective processor or computing device to perform operations. The operations can comprise operations or process steps described herein.

In some embodiments, processing component 110 may also comprise a storage interface 116 in electronic communication with processor 112. Storage interface 116 may be configured to provide a physical connection to storage component 130. For example, storage component 130 may comprise an internal hard drive or solid-state storage device. Storage interface 116 may include, for example, appropriate cables, drivers, wires, and the like to enable the physical connection. As a further example, in response to storage component 130 comprising a removable storage medium, such as a CD-ROM drive, DVD-ROM drive, USB drive, memory card, or the like, storage interface 116 may comprise an interface, a port, a drive, or the like configured to receive the removable storage medium and any additional hardware required to operate the interface, the port, the drive, or the like.

Processing component 110 may also comprise a communication interface 118 in electronic communication with processor 112. Communication interface 118 may be, for example, a serial communication port, a parallel communication port, an Ethernet communication port, or the like. Computing device 100 may comprise a communication medium 102. Communication medium 102 may be configured to enable electronic communication between processing component 110 and network 104. Communication medium 102 may be a cable, such as an Ethernet cable. In various embodiments, communication interface 118 may be configured for wireless communication via infrared, radio frequency (RF), WiFi®, optical, Bluetooth®, or other suitable wireless communication methods. Communication medium 102 may comprise one or more antennas configured to enable communication over free-space. Network 104 may be an intranet, the Internet, or a combination thereof. Each computing device 100 in a system may communicate with another device either directly or indirectly via a network.

In various embodiments, computing device 100 may be deployed within a system as part of, or to form, a distributed network. The distributed network may be based on one or more computing devices in wireless communication on a network. In some examples, computing device 100 may interact wirelessly over wired communication channels with other computing devices 100 or with other network-enabled devices. For example, SBB can communicate over a network with another remote computing device that administers content applications on the SBB.

In various embodiments, storage component 130 may comprise any suitable database, data structure, or the like capable of storing or maintaining data. Storage component 130 may comprise, for example, a hard drive, a solid-state drive, a removable memory card, and the like. Storage component 130 may comprise an interface 132 configured to enable communications with processing component 110, via storage interface 116. For example, storage interface 116 in processing component 110 and interface 132 in the storage component 130 define the physical layers between the processing component 110 and storage component 130, respectively, establishing communication therebetween. In various embodiments, storage component 130 includes block storage 134, with multiple blocks 136, in which data and files are saved. Each file stored in the storage component 130 may include metadata 138 and file data 140. Metadata 138 for a file includes, for example, pointers to particular blocks 136 in block storage 134 at which the file data 140 for the file is stored.

In some embodiments, file data 140 or metadata 138 can include metadata related to a unique identifier for a user, user's account, preferences, configurations, or other user-specific data. In that regard, computing device 100 (e.g., a playback device) can communicate with a central management system to configure loaded applications for an associated user. Data can be associated with a unique identifier of the user. In some examples, the identifier can be tied to a hotel rewards membership program enabling a hotel chain to automatically load the user's applications and settings onto an SBB before check in, during check in, or after check in.

In various embodiments, processor 112 in each device 100 may be configured to execute applications 120, as well as an operating system 122 for the device 100. Operating system 122 manages the resources of the device 100 and provides common services between applications 120 executing on processor 112. Operating system 122 may be stored on storage component 130, within memory 114, on a network resource, or a combination thereof. Operating system 122 may vary between devices 100 and is configured to control the hardware components for the associated device 100. Processor 112 may be configured to execute operating system 122 and each of the applications 120 stored in memory 114 or storage component 130. Operating system 122 can automatically install content applications (e.g., Sling TV®, YouTube®, Netflix®, Prime Video®, or other content applications) for a user based on configuration data retrievable in association with a unique identifier of the user.

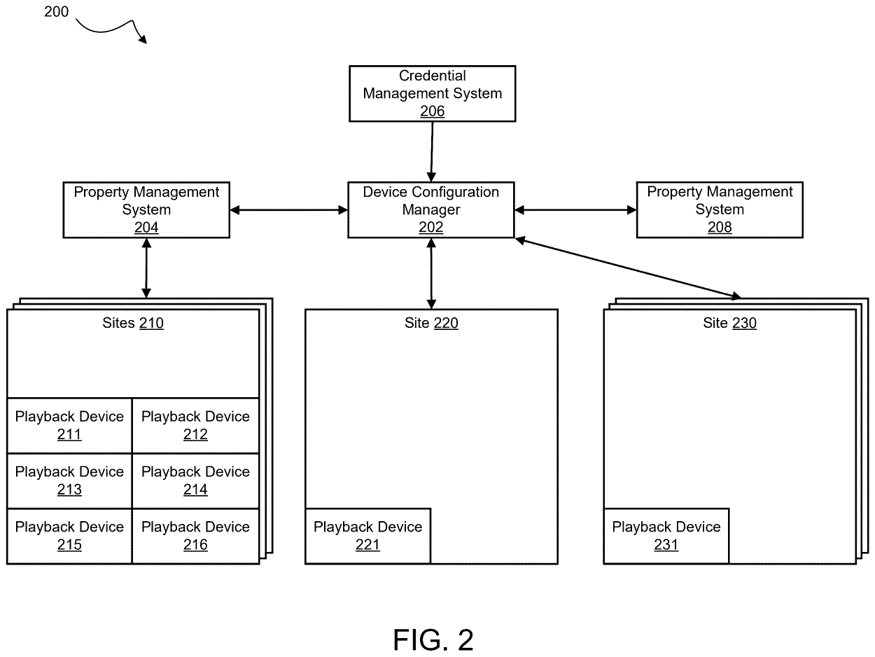

Referring now to FIG. 2, system 200 is shown for configuring playback devices, in accordance with various embodiments. In the example of FIG. 2, system 200 comprises device configuration manager (DCM) 202. DCM 202 and other elements of FIG. 2 can include on or more computing devices similar to computing device 100 of FIG. 1. For example, DCM 202 can comprise a computer, server, cloud-based system, virtual machine, containerized application, native application, web application, or other computing units. DCM 202 can further comprise permanent storage such as local storage, cloud-based storage, network storage, or other permanent storage suitable for storing configuration data.

In various embodiments, DCM 202 stores unique identifiers for individual users or user accounts in association with application configurations for the individual users. DCM 202 can create an account for a user in response to the user registering with DCM 202. For example, user can provide an email address or other login and password to create an account with DCM 202. The account can be created while user is on site at a property, while user is checked into a room at a property, before arrival at a property, after departure from a property, or at any other time. DCM 202 can associate various unique IDs from property management systems, credential management systems (CMS), or other computing systems that support unique identification of a user with temporary access to a playback device. Computing systems in communication with DCM 202 can retrieve configuration data or store configuration data for a user using one of the unique IDs associated with the user account.

In some examples, DCM 202 can create a dummy account for a user with access to a playback device such as, for example, playback device 213. The user may have access to playback device 213 in their room during a stay at a hotel. The user can configure playback device 213 with installations of media playback applications and login credentials for the applications. A unique identifier (e.g., a hotel rewards account number) can be provided for the user then associated with the dummy account. The data stored for the user in the dummy account can then be retrieved or modified using the unique identifier to configure devices in the future. Dummy accounts typically would have only a single unique identifier associated with, though in some examples a user can log in using their unique identifier and provide other unique identifiers (e.g., a different hotel rewards account number, a vacation rental account number, a device ID, or other identifier) to enable modification and retrieval of associated data at other sites outside the umbrella of the original hotel rewards account.

Various types of management systems can be in communication with device configuration manager 202 to store or retrieve configurations for guests or other users. For example, property management system (PMS) 204 may be in communication with DCM 202. PMS 204 can be a system used by a hotel chain (e.g., Hilton, Marriott, etc.), vacation rental manager, apartment manager, prison manager, or other dwelling unit management to manage their properties and guest interactions at various sites 210. For example, PMS 204 can store individual guest data in association with a unique identifier such as a rewards program account number for a hotel chain. Guest data associated with the rewards program number can include guest room assignments, guest activity, guest preferences, or other data related to the guest's interactions with the hotel chain. In another example, PMS 208 can store individual guest data in association with a unique identifier such as, for example, a user email used to register with a vacation rental company, or an account number assigned by a vacation rental company to a user in response to user registration.

PMS 204 can communicate with DCM 202 to retrieve and store user configuration data in association with a unique ID for the user. PMS 204 can retrieve or push configuration settings from or to individual playback devices 211-216 located at a site 210. In some examples, PMS 204 can be remote from individual sites 210 under management by PMS 204. PMS 204 can communicate with a computing device local to site 210 and configured to manage playback devices 211-216 at site 210. In some embodiments, PMS 204 can act as an intermediary between sites 210 and PMS 204. PMS 204 can communicate with DCM 202 using an application programming interface (API), a data stream, a messaging system, or using other techniques for communication across a private network, local-area network (LAN), wide-area network (WAN), public Internet, or other computing network.

In various embodiments, DCM 202 is in communication with CMS 206. CMS 206 can be a third-party credentialing system that assigns users a unique identification or device identification and enables users to access various computer networks using the unique identification or device identification. For example, CMS 206 can be a communication access system such as the system offered under the tradename Global Roaming Passphrase® by DISH Network, L.L.C. and its affiliates.

In the example of FIG. 2, site 220 can support CMS 206. A user using the credential management services of CMS 206 arrives at site 220. The user can login to CMS 206 and indicate they are present at site 220 and have access to playback device 221. In some examples, site 220 can detect credentials of a user or a device of the user and authenticate the user with CMS 206. Site 220 can indicate the user has access to playback device 221 in response to authentication. DCM 202 can retrieve application configurations and configure applications on playback device 221 in accordance with the profile of the user with access to playback device 221. DCM 202 is in direct communication with a local computing device of site 220 or with playback device 221 in the example of FIG. 2, though CMS 206 could act as an intermediary between DCM 202 and playback device 221 in various examples.

In various examples, PMS 208 of system 200 can be in communication with DCM 202. PMS 208 can be a property management system for a vacation rental company (e.g., VRBO® or Airbnb®), for an apartment management company, or for another entity or management system that comprises dwelling units with a separate site 230. DCM 202 can communicate with sites 230 or the playback device 231 at each site 230 directly. In some examples, PMS 208 can act as an intermediary between DCM 202 and site 230 or playback device 231. In some examples, DCM 202 can be a plugin, application, service, or other integrated component of PMS 204, CMS 206, or PMS 208. In some examples, PMS 204, CMS 206, or PMS 208 can comprise independent computing units similar to or the same as those described above for DCM 202 and computing device 100.

In various embodiments, a user can travel from site 210, to site 220, to site 230 and have their content applications automatically loaded onto a target computing device at each site. The applications can also be deleted in response to the user departing each respective site, in response to the user checking out, or in response to the target device otherwise being deprovisioned for the user. A persistent user profile stored by DCM 202 can thus reduce the time spent be users configuring temporarily assigned playback devices at different hotels, vacation rentals, dwelling units, etc. The automatic provisioning and deprovisioning can be performed before the user accesses the target playback device in some examples, resulting in a seamless user experience.

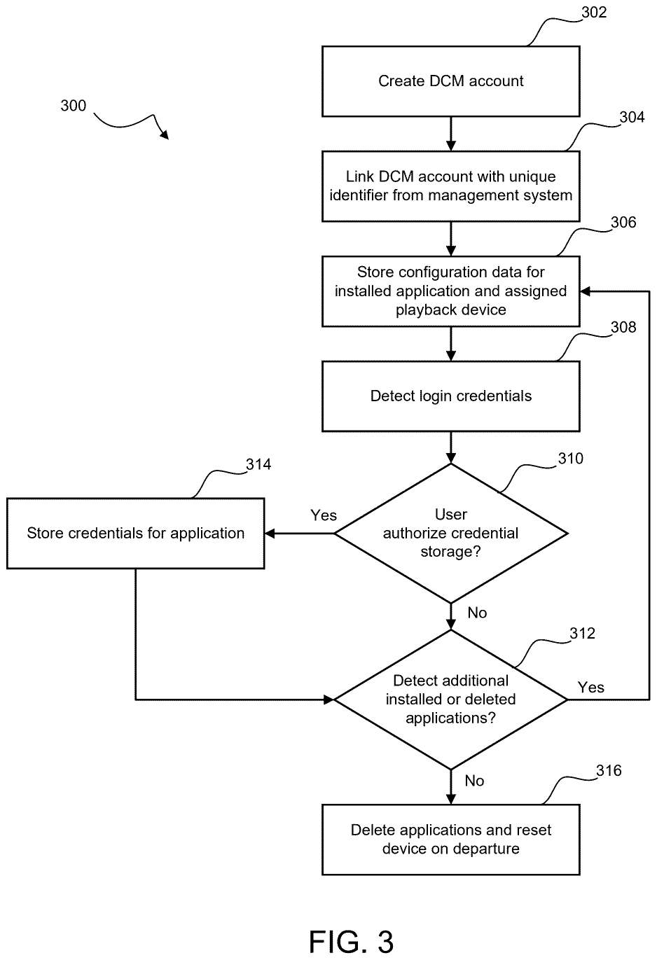

Referring now to FIG. 3, an example process 300 is shown for managing content applications on playback devices, in accordance with various embodiments. Process 300 can include creating an account with DCM 202 (Block 302). The account can be affirmatively created by a user using an assigned playback device 213 via an interface presented by the assigned playback device 213. The account can be a dummy account undetected by the user of an assigned playback device 213. The account can be created by the user using an interface on a personal computing device such as a smartphone, laptop, tablet, or computer. The user account can be created in any other way that uniquely assigns the account with DCM 202 to the user. In some examples, a unique identifier can be linked to the user account during creation.

In various examples, process 300 includes linking the DCM 202 account with a unique identifier from a management system (Block 304). The unique identifier can be provided by PMS 204 or 208, or from CMS 206, to DCM 202. For example, the unique identifier can comprise a rewards account number, a device identifier, a login token, email address, output from a cryptographic function, or other unique identifier associated with a user by the PMS 204, PMS 208, or CMS 206. In an example of a cryptographic output, PMS 204 can provide an encrypted user account number to DCM 202 obfuscate the user account number from DCM 202. The unique identifier can be provided directly by the user in some examples (e.g., as an email address or other identifier). DCM 202 may use the unique identifier as a key when creating the user account in block 302 in various embodiments. With user permission, a PMS can provide a user email address along with the unique identifier to act as a later access point for the user to register additional unique identifiers with DCM 202. For example, DCM 202 can email the user with a link to register additional unique identifiers in response to the user registering a first unique identifier.

In some examples, multiple keys can be provided to DCM 202 for association with the same user account. For example, a user may submit a first rewards account number for his current hotel stay during initial registration in block 304, and the user may submit additional rewards account numbers for different hotels during or after registration with DCM 202. In some embodiments, DCM 202 can enable the user to link additional identifiers to the DCM account after creation in follow-on screens of a GUI on the assigned playback device 213.

In various embodiments, a user can install content applications (e.g., Sling TV®, YouTube®, Netflix®, Prime Video®, Disney Plus®, Max®, etc.), select favorite channels, configure settings on installed content applications or the assigned playback device 213, or otherwise customize the experience on the assigned playback device 213. DCM 202 can store configuration data for installed applications and for the assigned playback device 213. Configuration settings can be updated at DCM 202 in response to uninstallation of an application, installation of a new application, or a settings change made by the user. The user may enter login credentials for an installed content application to authenticate their account with the third-party provider of the content application. System 200 can detect entry of login credentials (Block 308).

In various examples, the assigned playback device 213, DCM 202, or another device can prompt the user for authorization to store login credentials (Block 310). DCM 2302 can trigger a prompt for authorization to store credentials each time a user logs into an installed content application. In some examples, the prompt for authorization is presented once upon initial login or installation, and includes authorization for storage of future login credentials.

In response to authorization, DCM 202 can store credentials for an installed content application (Block 314). In some examples, the authorization enables DCM 202 to link directly with the third-party content provider on behalf of the user. Various embodiments can store the user's login name and login password for an application in an encrypted format, though plain text could be used in some embodiments. In some examples, a DCM 202 can store an access token that grants account access to the token holder.

In response to being denied permission to store credentials, or in response to completing credential storage, DCM 202 can continue monitoring for changes to the installed content applications on the assigned playback device 213 of the user. Changes to installed content applications or to settings can trigger storage or updates to configuration data for the installed content applications or assigned playback device 213 (Block 306). System 200 can delete installed content applications from playback device 213 and reset playback device 213 to default settings in response to departure of the user (Block 316). Departure can be detected in response to checkout from a hotel or vacation rental. Departure can be detected in response to termination of a lease agreement. Departure can be detected based on a pre-scheduled end of a reservation. In some examples, departure can be detected by CMS 206 based on a known device leaving a network or site. The stored configurations for settings and installed applications can be retrieved and used to configure a newly assigned playback device should a user visit another site compatible with reconfiguration of playback devices.

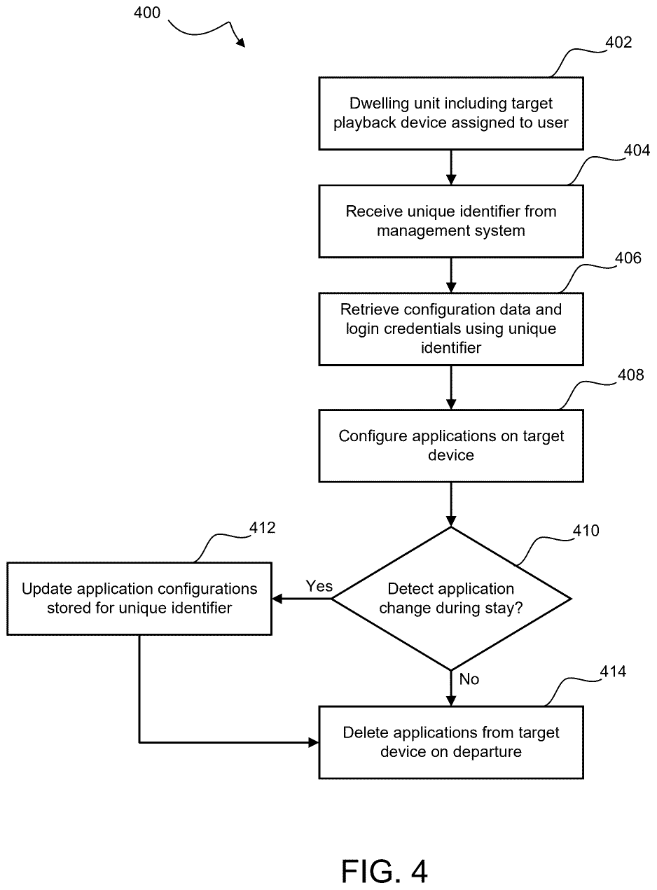

Referring now to FIG. 4, process 400 is shown for configuring playback devices, in accordance with various embodiments. System 200 can execute process 400 to configure or reconfigure playback devices for a returning user. In some examples, a dwelling unit (e.g., site 230) including a target playback device (e.g., playback device 231 of FIG. 1) is assigned to a user (Block 402). The dwelling unit can be assigned by PMS 204 or PMS 208 in various embodiments. In some embodiments, the dwelling unit can be assigned in response to a user booking a particular dwelling unit for a stay over a particular time. A dwelling unit can also be assigned in an apartment management system in response to a user leasing an apartments including managed content delivery. Other types of dwelling units can be assigned to a user in accordance with various embodiments.

Each dwelling unit may include one or more playback devices. The playback devices accessible from the dwelling unit can be automatically assigned to the user that will be staying in the dwelling unit over the period of the stay. Continuing a hotel-based example, a user may book a hotel stay from October 30 through November 1. On October 30 in preparation for checking, PMS 204 assigns the user to room number X at a property (e.g., site 210), which contains playback device 212, for the duration of the stay.

In various embodiments, DCM 202 can receive a unique identifier from a management system (Block 404). Continuing the hotel-based example, PMS 204 transmits a hotel rewards number to DCM 202 as a unique identifier. In a CMS example, a user can log into Wifi® at a vacation rental or hotel. The Wifi® system can recognize the device ID of the user's device. The device ID is transmitted to DCM 202 as a unique ID to determine whether the device or user are known.

DCM may use the unique identifier to retrieve configuration data and login credentials for the user (Block 406). The application configuration data can include installation data for content delivery applications such as, for example, which applications are installed, what the last known settings were on the installed applications, favorite channels, and which applications are most frequently used. In the event the target playback device lacks storage to install all previously installed applications, the usage data can be used to prioritize which applications will be installed.

In various embodiments, the applications and settings are configured on the target playback device (Block 408). DCM 202 and the management system (e.g., PMS 204 or CMS 206) can coordinate to install previously installed applications for the user. Previous favorite settings, time limits, alarms, or other settings on the target playback device can also be reconfigured to match the last known settings, closest similar settings, or other preferences selected by the user. DCM 202 and the management system can log into installed applications using previously stored credentials, if available.

In some embodiments, DCM 202 and the management system can continue to monitor the assigned playback device for changes to settings, preferences, favorites, or installed applications (Block 410). Changes can be monitored using a local computing device at the dwelling location (e.g., a hotel property similar to the example of site 210 of FIG. 2) to poll the assigned playback device. The assigned playback device can also be polled using a cloud-based monitor, DCM 202, a monitoring function of a management system, or any other polling mechanism. In some examples, the assigned playback device can run a monitoring agent that pushes configuration updates for storage by DCM 202.

In response to detecting a change, DCM 202 can update the installed content applications and configurations associated with the unique identifier. In some embodiments, DCM 202 can communicate with playback device 412 at the time of the user's departure to perform a single update to configurations associated with the user's unique identifier. Any detected changes, additions, deletions of installed content applications or user settings can be stored in the user's DCM account, which can also be indexed or accessed using the unique identifier. In response to the user's departure from the assigned dwelling unit and resulting revocation of access to the assigned playback device, the installed content applications and user settings on the playback can be deleted or reset to a default template (Block 414). The configuration wipe or reset can be triggered by a checkout time, by a checkout, by a location signal, or using any other trigger.

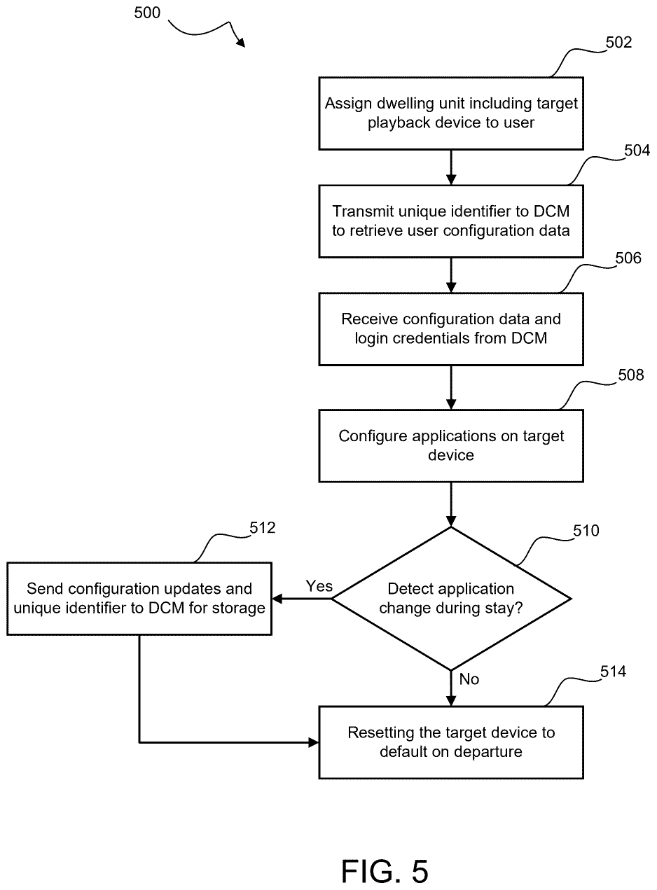

Referring now to FIG. 5, process 500 is shown for configuring playback devices from a PMS (e.g., PMS 204), in accordance with various embodiments. In some embodiments, steps of process 500 can be similar to or the same as steps of processes 400 or 300 in various embodiments. PMS 204 can assign a dwelling unit including a target playback device to a guest (Block 502). The dwelling unit can be assigned by PMS 204, PMS 208, or another PMS. The playback devices accessible from the dwelling unit can be automatically assigned to the user that will be staying in the dwelling unit over the period of the stay.

In various embodiments, PMS 204 can transmit a unique identifier (e.g., hotel rewards number) of a user to DCM 202 to retrieve configuration data for the user (Block 504). DCM 202 may use the unique identifier to retrieve configuration data and login credentials for the user. The DCM 202 may transmit the configuration data corresponding to the unique identifier to the PMS for deployment to playback devices or to sites managed by the PMS.

In various embodiments, the PMS then receives the configuration data and login credentials from DCM 202 (Block 506). The applications and settings are configured on the target playback device (Block 508). DCM 202, the PMS, a local computing device at the site hosting the target playback device, or the target playback device can coordinate to install previously installed applications and settings for the user. The PMS can also manage logging into installed applications using previously stored credentials, if available.

In some embodiments, the PMS can continue to monitor the assigned playback device for changes to settings, preferences, favorites, or installed applications (Block 510). In response to detecting a change, the PMS can send configuration updates regarding the installed content applications and configurations with the unique identifier to DCM 202 (Block 510). The configuration settings can be sent and updated using an API, for example, or other communication techniques. In response to the user's departure from the assigned dwelling unit and resulting revocation of access to the assigned playback device, the installed content applications and user settings on the playback can be deleted or reset to a default template (Block 514).

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment (for example, A and B, A and C, B and C, or A and B and C).

References to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

What is claimed is:

1. An automated process comprising:
linking, by a device configuration manager (DCM), an account of a guest to a unique identifier of the guest received from a property management system (PMS);
storing, by the DCM, configuration data of a playback device in association with the account in response to the playback device being configured while assigned to the guest, wherein the configuration data identifies a content application installed on the playback device;
prompting for an authorization to store a login credential for the content application;
storing the login credential in response to receiving the authorization; and
deleting the content application from the playback device in response to a departure of the guest.

2. The automated process of claim 1, wherein the unique identifier comprises an account number for a hotel rewards program.

3. The automated process of claim 1, wherein the account is created in response to the guest submitting an email address.

4. The automated process of claim 1, wherein the account comprises a dummy account created without input from the guest.

5. The automated process of claim 1, wherein the configuration data comprises a favorite channel identified during a stay of the guest.

6. The automated process of claim 1, further comprising installing, by the DCM, the content application on a second playback device in response to receiving the unique identifier from the PMS.

7. The automated process of claim 6, further comprising updating, by the DCM, the configuration data in response to the guest installing a second content application on the second playback device.

8. The automated process of claim 7, further comprising resetting the second playback device to a default configuration in response to a second departure of the guest.

9. An automated process, comprising:
assigning a dwelling unit to a user, the dwelling unit including an assigned playback device;
transmitting a unique identifier associated with the user to a device configuration manager (DCM) to retrieve configuration data of the user;
configuring the assigned playback device based on the configuration data; and
resetting the assigned playback device to a default configuration in response to a departure of the user from the dwelling unit.

10. The automated process of claim 9, further comprising updating the configuration data of the user at the DCM in response to a content application being installed on the assigned playback device.

11. The automated process of claim 9, wherein the configuration data of the user comprises a content application installed on the assigned playback device and a login credential for the content application.

12. The automated process of claim 11, further comprising configuring a target playback device in a second dwelling unit in response to the user being assigned to the second dwelling unit.

13. The automated process of claim 12, further comprising resetting the target playback device to the default configuration in response to the user checking out of the second dwelling unit.

14. The automated process of claim 9, further comprising transmitting the configuration data of the assigned playback device to the DCM for configuration of other playback devices assigned to the user.

15. A computer-based system, comprising:
a first playback device located in a first dwelling unit at a first property;
a second playback device located in a second dwelling unit at a second property; and
a device configuration manager (DCM) configured to manage the first playback device and the second playback device, wherein the DCM associates configuration data from the first playback device with a unique identifier of a user in response to the user being assigned the first dwelling unit, wherein the DCM configures the second playback device using the configuration data from the first playback device in response to the user being assigned the second dwelling unit.

16. The computer-based system of claim 15, wherein the DCM updates the configuration data in response to the user installing a content application on the second playback device.

17. The computer-based system of claim 15, wherein the configuration data comprises an installed content application and login credentials for the installed content application.

18. The computer-based system of claim 15, further comprising a property management system (PMS) that includes the DCM.

19. The computer-based system of claim 15, wherein the DCM is in electronic communication over a network with a property management system (PMS) that manages the first property and the second property.

20. The computer-based system of claim 19, wherein the PMS provides the unique identifier comprising a rewards account number to the DCM.
